(19) United States
(12) Patent Application Publication
(10) Pub. No.: US 2013/0041073 A1
(43) Pub. Date: Feb. 14, 2013

(54) PLASTICIZING MIXTURE FOR A HYDRAULIC COMPOSITION

(71) Applicants: Emmanuel Villard, Saint-Christo-en-Jarez (FR); Martin Mosquet, Bourgoin-Jallieu (FR); David Rinaldi, Lyon (FR); Horacio Naranjo, Jardin (FR); Jean-Michel Laye, Injambakkan (FR)

(72) Inventors: Emmanuel Villard, Saint-Christo-en-Jarez (FR); Martin Mosquet, Bourgoin-Jallieu (FR); David Rinaldi, Lyon (FR); Horacio Naranjo, Jardin (FR); Jean-Michel Laye, Injambakkan (FR)

(73) Assignee: LAFARGE, Paris (FR)

(21) Appl. No.: 13/638,689

(22) PCT Filed: Mar. 29, 2011
(86) PCT No.: PCT/FR11/50694

§ 371 Date: Oct. 25, 2012

(30) Foreign Application Priority Data
Apr. 2, 2010 (FR) 1052501

(51) Int. Cl. C08L 29/04; C04B 24/26; C08L 33/10

(52) U.S. Cl. 524/5; 524/523

(57) ABSTRACT

A mixture for a hydraulic composition, including an inerting agent for at least partially neutralizing the harmful effects of impurities in a hydraulic composition on the workability of the hydraulic composition; a first superplasticizer different from the inerting agent; and a second superplasticizer different from the first superplasticizer and the inerting agent and having a maximum plasticizing action at 20° C. developing after the peak of the plasticizing action at 20° C. of the first superplasticizer.

The present invention relates to a plasticizing mixture for compositions comprising a hydraulic binder, for example concrete.

When the components of concrete, hydraulic binder, fine and coarse aggregates, are mixed with water, a composition is obtained which sets and hardens as a result of reactions and hydration processes, and which after hardening, retains its strength and stability even under water. Before setting, concrete can be worked for a limited time, generally called the window of workability. The window of workability can be defined as the time during which the spread or slump of the cement composition is above a given value.

One difficulty which has to be taken into account when making concrete relates to the amount of mixing water to use. In fact, the amount of mixing water must be sufficient to allow suitable working of the concrete. However, an increase in the amount of mixing water tends to reduce the compressive strength of the concrete obtained after hardening.

To obtain concrete having satisfactory fluidity during the window of workability without using an excessive amount of water, the concrete can comprise a mixture of several admixtures called plasticizing agents, water reducers, plasticizers or superplasticizers.

It can be difficult to manufacture hydraulic compositions having constant properties. The quality of the raw materials is often the source of these variations. In particular, it has been established that impurities, for example clays, contained in sands and/or mineral additions can generate fluctuations in properties of the hydraulic compositions, notably a decrease in the window of workability of the hydraulic compositions.

The present invention relates to a plasticizing mixture for preparing a hydraulic composition which is useful for reducing the undesirable effects associated with the presence of harmful impurities, for example clays, in said hydraulic composition.

For this purpose, the present invention proposes a mixture for a hydraulic composition, comprising:
an inerting agent suitable for at least partially neutralizing the harmful effects of impurities in the hydraulic composition on the workability of the hydraulic composition;
a first superplasticizer different from the inerting agent; and
a second superplasticizer different from the first superplasticizer and the inerting agent and having a maximum plasticizing action at 20° C. developing after the peak of the plasticizing action at 20° C. of the first superplasticizer.

The present invention advantageously makes it possible to manufacture hydraulic compositions which are easy to use. These hydraulic compositions have an appropriate rheology, preferably corresponding to a duration of workability (after mixing) of at least one hour.

Moreover, the plasticizing mixture can be made at reduced cost since an inerting agent generally costs less than a superplasticizer.

Moreover, the inerting agent can advantageously be selected to have little plasticizing action or to have no plasticizing action, so that each component of the mixture exerts essentially a single function (inerting function for the inerting agent and plasticizing function for the first and second superplasticizers). Determination of the proportions of each component of the mixture is thus facilitated.

Finally, the invention, has the advantage that it can be applied in one of the following industries: the building industry, the chemicals (admixture manufacturing) industry, in the construction markets (building, civil engineering, roadmaking, or prefabrication plant), in the cement industry or concrete mixing plants.

Other advantages and features of the invention will become clear on reading the description and the nonlimiting examples given below purely for purposes of illustration.

The term “hydraulic binder” means, according to the present invention, any compound having the property of being hydrated in the presence of water and the hydration of which makes it possible to obtain a solid having mechanical characteristics. The hydraulic binder according to the invention can in particular be cement, plaster or lime. Preferably, the hydraulic binder according to the invention comprises a cement and admixtures.

The term “hydraulic composition” means, according to the present invention, a mixture of a hydraulic binder, with water (called mixing water), optionally aggregates, optionally admixtures, and optionally mineral additions. A hydraulic composition can for example be a high performance concrete, a very high performance concrete, a self-placing concrete, a self-leveling concrete, a self-compacting concrete, a fibre-reinforced concrete, a readymix concrete or a colored concrete. The term “concrete” also means concrete which has undergone a finishing operation such as roughened concrete, deactivated or washed concrete, or polished concrete. Prestressed concrete is also covered by this definition. The term “concrete” comprises mortars; in this precise instance the concrete comprises a mixture of a hydraulic binder, sand, water, optionally admixtures and optionally mineral additions. The term “concrete” according to the invention denotes fresh concrete or hardened concrete without distinction. Preferably, the hydraulic composition according to the invention is a cement slurry, a mortar, a concrete, a plaster paste or a lime slurry. Preferably, the hydraulic composition according to the invention is a cement slurry, a mortar or a concrete. The hydraulic composition according to the invention can be used directly on site in the fresh state and cast in formwork suitable for the intended application, or in prefabrication plant, or as a coating on a solid substrate.

The term “Portland cement” means, according to the invention, a cement of the CEM I, CEM II, CEM III, CEM IV or CEM V type according to the “Cement” standard NF EN 197-1.

The term “setting” means, according to the present invention, the transition of a hydraulic binder to the solid state by the chemical reaction of hydration. Setting is generally followed by the period of hardening.

The term “hardening” means, according to the present invention, acquisition of the mechanical properties of a hydraulic binder, after the end of setting.

The term “element for the construction area” means, according to the present invention, any constituent element of a structure, for example a floor, a screed, a foundation, a wall, a partition, a ceiling, a beam, a worktop, a pillar, a bridge pier, a concrete block, a pipe, a post, a cornice, a roadmaking element (for example a kerbstone), a tile, a covering (for example a road surface), plastering (for example of a wall), a plasterboard, an insulating element (acoustic and/or thermal).

The term “clays” means, according to the present invention, aluminum and/or magnesium silicates, notably phyllosilicates with a layered structure, typically with layer spacing from about 7 to about 14 Å. The clays frequently encountered in sands are for example montmorillonite, illite, kaolinite, muscovite and chlorites. The clays can be of the 2:1 type but also of the 1:1 type (kaolinite) or 2:1:1 type (chlorites).

The term “swelling clays” means, according to the present invention, clays which possess cations, in their interlamellar spaces, capable of being hydrated in the presence of water (as vapor or liquid). The swelling clays, called generically smectites, notably comprise clays of type 2:1, for example montmorillonite.

The term “non-swelling clays” means, according to the present invention, clays whose interlamellar space does not increase in the presence of water. The nonswelling clays notably comprise clays of the 1:1 type (notably kaolinite) or of the 2:1:1 type (notably chlorites).

The term “clay inerting” means, according to the present invention, at least partial neutralization of the harmful effects due to the presence of clay in a hydraulic composition, notably a hydraulic composition comprising a superplasticizer.

“Hydrogen bond” or “hydrogen bridge” means, according to the present invention, a noncovalent physical bond, of the dipole-dipole type, of low strength (twenty times weaker than a classical covalent bond), and joining molecules together and which comprises a hydrogen atom. It requires a hydrogen bond donor and a hydrogen bond acceptor. The donor is an acidic hydrogen compound, i.e. comprising at least one heteroatom (for example nitrogen, oxygen, or sulfur) bearing a hydrogen atom (for example in amines, alcohols or thiols). The acceptor consists of at least one heteroatom (solely nitrogen, oxygen or sulfur) bearing lone pairs.

“Atom capable of forming a hydrogen bond” means, according to the present invention, a hydrogen atom or an electronegative atom, for example nitrogen, oxygen or sulfur, of the organic molecule according to the invention capable of forming at least one hydrogen bond.

The term “plasticizer/water reducer” means, according to the present invention, an admixture which, without altering the consistency, makes it possible to reduce the water content of a given concrete, or which, without altering the water content, increases its slump/spread, or which produces both effects at the same time. Standard EN 934-2 stipulates that the water reduction must be greater than 5%. Water reducers can, for example, be based on lignosulfonic acids, hydroxycarboxylic acids or treated carbohydrates.

The term “superplasticizer” or “superplasticizing agent” or “super water reducer” means, according to the present invention, a water reducer which makes it possible to reduce the amount of water required for making a concrete by more than 12%. A superplasticizer displays a plasticizing action since, for one and the same amount of water, the workability of the concrete is increased in the presence of the superplasticizer.

The term “superplasticizer with immediate action” means, according to the present invention, a superplasticizer whose maximum plasticizing action at 20° C. is generally obtained in the first fifteen minutes following initial contact of the superplasticizer with the hydraulic binder for usual dosages.

The term “superplasticizer with delayed action” means, according to the present invention, a superplasticizer whose plasticizing action increases over time at least for a part of the required window of workability of the hydraulic composition so that the maximum plasticizing action of the superplasticizer at 20° C. is obtained at least more than fifteen minutes after initial contact of the superplasticizer with the hydraulic binder.

The plasticizing action of the superplasticizer with immediate action and of the superplasticizer with delayed action is measured by measuring the spread and/or slump, for example according to standard EN 12350-2 “Tests for fresh concrete—Part 2: Slump test”. The plasticizing action of the superplasticizer is maximal when the measured spread/slump of the hydraulic composition comprising only this superplasticizer is maximal.

The plasticizing action of the superplasticizer can be increased by an increase in the capacity of the superplasticizer to be adsorbed by the mineral components (notably the cement grains) of the hydraulic composition. For this purpose, one possibility is to increase the anionic charge density of the superplasticizer. An increase in the charge density of the superplasticizer can be obtained by two different phenomena, which can take place simultaneously:
increase in the number of charges carried by the polymer; and
reduction in molecular weight of the polymer.

The molecular weight of the superplasticizer can be reduced by providing a superplasticizer comprising a main chain and pendant chains (at least three) attached to the main chain and which can detach from the main chain when the superplasticizer is in the hydraulic composition.

The separation of pendant chains and/or increase in the number of charges carried by the superplasticizer can be obtained by providing a superplasticizer comprising hydrolyzable chemical functions which, under the effect of the hydroxide ions (OH⁻) in the hydraulic composition, can be transformed to supply carboxylate functions COO⁻. The hydrolyzable chemical functions are for example anhydrides, esters and amides. A polymer comprising hydrolyzable chemical functions in the conditions of basicity and in the window of workability of the hydraulic composition is called a hydrolyzable polymer.

Impurities, for example clays, contained in sands and/or mineral additions are known to lead to fluctuations of properties of hydraulic compositions comprising only a superplasticizer with immediate action of the polyalkyleneoxide polycarboxylate type. In particular, a drop in initial slump or initial spread is generally observed relative to a hydraulic composition not comprising impurities.

According to document WO 98/58887, adsorption of the superplasticizer with immediate action by swelling clays of the 2:1 type present in sands is the cause of this decrease in effectiveness. Document WO 98/58887 envisages the use of agents which modify the activity of clay, for example by decreasing its capacity for adsorption or by performing preadsorption of the clay.

The inventors have demonstrated that when a plasticizing mixture comprising a superplasticizer with immediate action and a superplasticizer with delayed action is used in a hydraulic composition comprising impurities, notably clays, a reduction of the decrease in initial slump/spread is observed. Conversely, the slump/spread tends to decrease over time, in contrast to what is observed in the absence of impurities. Inerting agents can be used conventionally when a decrease in initial slump/spread of a hydraulic composition comprising a superplasticizer with immediate action is observed. However, the inventors have shown in numerous tests that, surprisingly, the use of inerting agents also makes it possible to avoid the decrease over time of the slump/spread of a hydraulic composition comprising a superplasticizer with immediate action and a superplasticizer with delayed action for which the initial slump/spread is suitable.

A possible explanation would be that when a plasticizing mixture comprising a superplasticizer with immediate action and a superplasticizer with delayed action is used, it is the superplasticizer with delayed action which would be adsorbed preferentially by the clays, rather than the superplasticizer with immediate action. The absence of a decrease or a slight decrease in initial slump/spread would be due to the fact that there is little or no change in the concentration of the superplasticizer with immediate action. Moreover, the undesirable decrease in slump/spread which occurs later would be due to the fact that a proportion of the superplasticizer with delayed action is adsorbed by the impurities. The inerting agents are used conventionally when a decrease in initial slump/spread of a hydraulic composition comprising a superplasticizer with immediate action is observed. However, the inventors have demonstrated that, surprisingly, these inerting agents also make it possible to avoid adsorption of the superplasticizers with delayed action by the impurities even though the initial structure of the superplasticizers with delayed action is different from that of the superplasticizers with immediate action.

The present invention also relates to a hydraulic binder comprising a plasticizing mixture as defined above. The present invention also relates to a hydraulic composition comprising a hydraulic binder as defined above and aggregates.

Superplasticizer with Immediate Action or First Superplasticizer

The first superplasticizer can be any superplasticizer with immediate action used conventionally in industry, for example those defined in European standard EN 934-2.

Superplasticizers which are of the polyphosphonate-polyox or polysulfonate-polyox type or of the polyalkyleneoxide polycarboxylate type (also called polycarboxylate-polyox or PCP) can be used as the first superplasticizer. An example of the first superplasticizer is that described in documents EP-A-537872, US20030127026 and US20040149174.

An example of the first superplasticizer corresponds to a copolymer comprising at least one unit of formula (I)

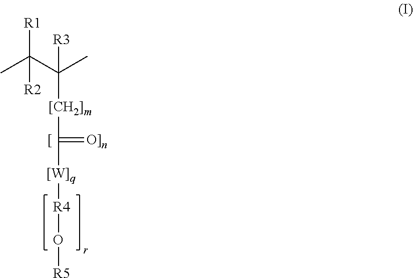

and at least one unit of formula (II)

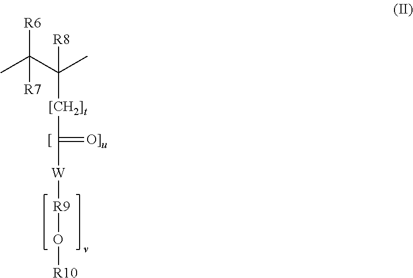

where R1, R2, R3, R6, R7 and R8 are independently a hydrogen atom, a linear or branched C₁ to C₂₀ alkyl radical, or an aromatic radical, or a radical —COOR11 with R11 representing independently a hydrogen atom, a linear or branched C₁ to C₄ alkyl radical, a monovalent, divalent or trivalent cation or an ammonium group;

R10 is a hydrogen atom, a linear or branched C₁ to C₂₀ alkyl radical, or an aromatic radical;

R4 and R9 are independently a linear or branched C₂ to C₂₀ alkyl radical;

R5 is a hydrogen atom, a C₁ to C₂₀ alkyl group or an anionic or cationic group, for example a phosphonate group, a sulfonate group, a carboxylate group, etc.;

W is an oxygen or nitrogen atom or an NH radical;

m and t are independently integers in the range from 0 to 2;

n and u are independently integers equal to 0 or 1;

q is an integer equal to 0 or 1;

r and v are independently integers in the range from 0 to 500; and the molecular weight of said copolymer is in the range from 10 000 to 400 000 dalton.

Preferably, the radical R1 or R6 is a hydrogen atom. Preferably, the radical R2 or R7 is a hydrogen atom. Preferably, the radical R3 or R8 is a methyl radical or hydrogen. Preferably, the radical R4 or R9 is an ethyl radical.

Preferably, the copolymer used according to the invention or a salt thereof has an integer r from 1 to 300, preferably from 20 to 250, more preferably from 40 to 200, even more preferably from 40 to 150.

The superplasticizer can correspond to a salt of the copolymer defined above.

The copolymer can comprise several different units according to formula (I) having, notably, different radicals R5.

An example of first superplasticizer is that obtained by polymerization:
of at least one ionic monomer of the phosphonic, sulfonic or carboxylic type, preferably carboxylic and advantageously of the (meth)acrylic type; and
of at least one monomer of the polyoxyalkylene (C₁ to C₄) glycol (meth)acrylate type, for example of the polyethylene glycol (PEG) (meth)acrylate type, whose molecular weight is for example in the range from 100 to 10000, preferably from 500 to 7500 and advantageously from 750 to 5000.

The first monomer/second monomer molar ratio can vary widely, for example 90:10 to 45:55, preferably 80:20 to 55:45.

It is possible to use one or more third monomer(s), for example those selected from:

(a) acrylamide type, for example N,N-dimethylacrylamide, 2,2′-dimethylamino (meth)acrylate or salts thereof, 2,2′-dimethylaminoalkyl (meth)acrylate or its salts with the alkyl group and in particular ethyl and propyl, and generally any monomer comprising a function of the amine or amide type;

(b) hydrophobic type, for example C₁ to C₁₈ alkyl (meth)acrylate, in particular methyl or ethyl.

The amount of this third monomer can vary from 5 to 25 mol % of the total of the monomers.

The first superplasticizer is of a form which can vary from the liquid form to the solid form, passing through the waxy form.

The dosage of the first superplasticizer relative to the hydraulic binder generally varies from 0.1 to 5 wt % (percentage calculated based on the dry extract of the first superplasticizer), preferably from 0.1 to 2 wt % relative to the mass of the hydraulic binder. When the first superplasticizer is liquid, the amount of the first plasticizer is preferably from 1 to 10, preferably from 2 to 7 litres per cubic metre of fresh concrete.

The first superplasticizer can correspond to a mixture of superplasticizers with immediate action, to a mixture of at least one superplasticizer with immediate action and a plasticizer, for example a lignosulfonate, or to a mixture of at least one superplasticizer with immediate action and a molecule of the gluconate type.

Superplasticizer with Delayed Action or Second Superplasticizer

The second superplasticizer is a superplasticizer whose plasticizing action increases at least temporarily over time in conditions of basicity and in the window of workability of the hydraulic composition. Preferably, the second superplasticizer does not have a plasticizing action initially, i.e. the initial slump/spread of the hydraulic composition (less than 5 minutes after mixing the components of the hydraulic composition) does not vary, regardless of the concentration of the superplasticizer with delayed action.

According to a practical example of the present invention, the density of adsorption sites of the second superplasticizer increases in the window of workability of the hydraulic composition.

According to a practical example of the present invention, the anionicity of the second superplasticizer increases in the hydraulic composition in the window of workability.

The second superplasticizer can comprise at least one polymer which is hydrolyzable in conditions of basicity and in the window of workability of the hydraulic composition. As the hydraulic composition obtained during manufacture of a concrete according to the invention has a basic pH, reactions of hydrolysis take place which lead to a change in the structure of the hydrolyzable polymer and to a change in the properties of the hydrolyzable polymer, in particular an increase in the plasticizing action of the hydrolyzable polymer. According to a practical example, the hydrolyzable polymer is of the polyalkyleneoxide polycarboxylate type.

Examples of superplasticizers with delayed action are described in documents EP 1 136 508, WO 2007/047407 and US 2009/0312460.

An example of the second superplasticizer corresponds to a copolymer comprising at least one unit according to formula (I) and at least one unit according to formula (II).

Relative, to the mass of the final hydraulic binder, the amount of the second superplasticizer varies from 0.01 to 1%, preferably from 0.05 to 0.5 wt % (percentage calculated from the dry extract of the second superplasticizer) relative to the mass of the hydraulic binder.

The second superplasticizer can correspond to a mixture of superplasticizers with delayed action.

Inerting Agent

The mixture for a hydraulic composition according to the invention can comprise at least one inerting agent. According to a practical example, the mixture for a hydraulic composition can comprise an inerting agent particularly effective for inerting swelling clays and an inerting agent particularly effective for inerting nonswelling clays.

According to a practical example of the invention, the inerting agent for swelling clays is a water-soluble cationic polymer having a cationicity greater than 0.5 meq/g, preferably greater than 1 meq/g, and more preferably greater than 2 meq/g.

According to a practical example of the invention, the cationic polymer has an intrinsic viscosity less than 1 dl/g, preferably less than 0.8 dl/g, and more preferably less than 0.6 dl/g.

The cationic polymers can have a linear, comb or branched structure. Preferably, they have a linear structure.

The cationic groups of the cationic polymers can notably be phosphonium, pyridinium, sulfonium and quaternary amine groups, the latter being preferred. These cationic groups can be situated in the main chain of the cationic polymer or as a pendant group.

The cationic polymers correspond, for example, to the cationic polymers described in patent application WO2006032785.

The cationic polymer can be obtained directly by a known method of polymerization, such as radical polymerization or polycondensation.

It can also be prepared by post-synthesis modification of a polymer, for example by grafting groups bearing at least one cationic function onto a polymer chain bearing suitable reactive groups.

The polymerization is carried out starting from at least one monomer bearing a cationic group or a suitable precursor.

The cationic polymers obtained from monomers bearing amine and imine groups are particularly useful. Nitrogen, can be quaternized after polymerization in a known manner, for example by alkylation by means of an alkylating compound, for example by methyl chloride, or in an acid medium, by protonation.

The cationic polymers containing cationic quaternary amine groups are particularly suitable.

Among the monomers already bearing a cationic quaternary amine function, we may notably mention diallyldialkyl ammonium salts, quaternized dialkylaminoalkyl (meth)acrylates, and (meth)acrylamides N-substituted with a quaternized dialkylaminoalkyl.

The polymerization can be carried out with nonionic monomers, preferably short chain, having 2 to 6 carbon atoms. Anionic monomers can also be present since they do not affect the cationic groups.

In the context of modification of polymers by grafting, grafted natural polymers, for example cationic starches, may be mentioned.

Advantageously, the cationic polymer contains groups whose cationic character only appears in an acid medium. The tertiary amine groups, cationic through protonation in an acid medium, are particularly preferred. The absence of ionic character in hydraulic compositions of the concrete or mortar type having an alkaline pH makes it possible to improve their robustness versus other ionic, notably anionic, compounds.

As an example, cationic polymers of the polyvinylamine family may be mentioned, which can be obtained by polymerization of N-vinylformamide, followed by hydrolysis. The quaternized polyvinylamines can be prepared as described in U.S. Pat. No. 5,292,441. Polymers of the polyethyleneimine type are also suitable. The latter are quaternized by protonation.

The cationic polymers obtained by polycondensation of epichlorohydrin with a mono- or dialkylamine, notably methylamine or dimethylamine, are particularly preferred. Their preparation is described for example in U.S. Pat. No. 3,738,945 and U.S. Pat. No. 3,725,312.

The unit of the cationic polymer obtained by polycondensation of dimethylamine and of epichlorohydrin can be represented as follows:

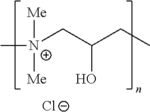

The polymers of the polyacrylamide type modified by Mannich reaction are also suitable, for example polyacrylamide N-substituted with a dimethylaminomethyl group.

The cationic polymers obtained by polycondensation of dicyandiamide and formaldehyde are also suitable. These polymers and the method of production thereof are described in patent FR 1 042 084.

According to a preferred embodiment, the cationic polymer is obtainable by condensation of dicyandiamide with formaldehyde in the presence of:
A) a polyalkylene glycol; and/or
B) a polyalkoxylated polycarboxylate; and/or
C) an ammonium derivative.

The precise chemical constitution of the cationic polymer thus obtained is not known precisely. It will therefore be described hereunder essentially by its method of preparation.

The inerting agent can correspond to a mixture of various inerting agents.

Method of Preparing the Inerting Agent for Swelling Clays

The inerting agent is obtainable by condensation of dicyandiamide with formaldehyde, optionally in the presence of other compounds, notably a polyalkylene glycol (A), a polyalkoxylated polycarboxylate (B) and/or a quaternizing agent (C).

The condensation reaction between dicyandiamide and formaldehyde requires 2 moles of formaldehyde per 1 mole of dicyandiamide, according to the following possible reaction scheme (1):

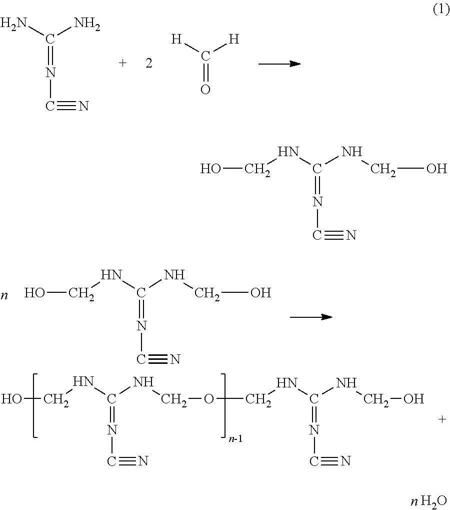

Thus, the molar ratio of formaldehyde to dicyandiamide is preferably in the range from 0.8:1 to 4:1, in particular from 1:1 to 3:1. A molar excess greater than 4 does not provide any additional advantage, but can lead to undesirable caking.

It is particularly preferable to carry out the reaction with a slight stoichiometric excess of formaldehyde, with a molar ratio of formaldehyde to dicyandiamide in the range from 2.2:1 to 2.8:1.

Preferably, the inerting agent for swelling clays is obtained by condensation of formaldehyde with dicyandiamide in the presence of additional compounds. In fact, this makes it possible to adjust the properties of the inerting agent, notably its solubility in water and its affinity for the swelling clays.

The polyalkylene glycol (compound A) is preferably a compound of formula (III):

R12-O—[R13-O]ₙ—R14 (III)

in which:

R13 is a C₁ to C₄ alkyl group, preferably an ethyl and/or propyl group;

R12 and R14 are independently of one another a hydrogen atom or a C₁ to C₄ alkyl group, preferably a methyl group; and

n is a number from 25 to 1000.

As an example, compound A can be polyethylene glycol, polypropylene glycol, an ethylene oxide/propylene oxide copolymer or a mixture of these various compounds.

Preferably, it is polyethylene glycol.

The molecular weight of compound A is preferably from 1000 to 35000.

It has been demonstrated by measurements of viscosity that the presence of compound A modifies the structure of the inerting agent formed as well as its performance.

The amount of compound A used in the reaction can if necessary be less than that of the principal reactants dicyandiamide and formaldehyde.

Thus, the reaction mixture generally contains 0 to 10 wt %, preferably 0.5 to 3 wt %, and more preferably from 0.8 to 1 wt % of compound A.

Compound B is a PCP as defined above in connection with formulae (I) and (II).

Advantageously, the reaction mixture contains 0.1 to 10 wt %, preferably 0.5 to 5 wt %, and more preferably from 0.5 to 2 wt % of compound B.

The ammonium derivative (compound C) has the main function of increasing the ionic character of the polymer by supplying cationic functions. The ionic character of the polymer contributes greatly to its solubility in water and to its affinity for the swelling clays, and is therefore advantageous in view of the intended application.

Preferably, the ammonium ion of the ammonium derivative is of the following formula (IV):

NH(R15)₃⁺ (IV)

in which

groups R15, which may be identical or different, correspond to hydrogen or to a C₁ to C₆ alkyl group.

Among suitable ammonium derivatives, we may notably mention ammonium halides, for example ammonium chloride, ammonium bromide and ammonium iodide, ammonium sulfate, ammonium acetate, ammonium formate, ammonium nitrate, ammonium phosphate. Ammonium formate is preferred.

The amount of compound C used can vary considerably. However, the molar ratio of compound C to dicyandiamide is preferably from 1 to 1.5 and more preferably from 1.1 to 1.3. Typically, the reaction mixture contains 1 to 10 wt %, preferably 3 to 8 wt %, and more preferably from 6 to 8 wt % of compound C.

The condensation reaction takes place in a suitable solvent, water being quite particularly preferred.

The amount of solvent in the reaction mixture is selected to obtain dissolution of the various components. The reaction mixture can comprise from 10 to 80 wt %, preferably from 20 to 70 wt % of solvent.

Generally it is preferable to limit the amount of water in the reaction mixture, in order to shift the equilibrium of the condensation reaction toward the desired product. It is advantageous to add the additional water after the reaction when a dilute product is desired.

It may be advantageous to add other conventional additives in the polymerizations, for example molecular terminating agents. These compounds make it possible to control the size of the molecules synthesized and therefore their molecular weight and thus decrease the polydispersity index. Sulfamic acid is an example of a suitable terminating agent.

The condensation reaction takes place quickly, generally in the space of about 30 minutes to 4 hours. The reaction rate depends on the temperature, which can be between room temperature and the boiling point of the reaction mixture. Preferably, it varies from 20 to 95° C., preferably from 60 to 70° C. The reaction time is longer at lower temperature. However, it is undesirable to maintain a high temperature for a long time, as this can lead to degradation of the product.

Advantageously, the cationic polymer is used directly at the end of the reaction, without previous purification. It can therefore contain products other than the cationic polymer expected according to reaction scheme (1) shown above.

The inerting agent for nonswelling clays can comprise an organic molecule having a cationic charge density strictly less than 0.5 meq/g and can comprise at least two atoms, each capable of forming at least one hydrogen bond.

Preferably, the inerting agent for nonswelling clays is water-soluble. The inerting agent for nonswelling clays can be an uncharged organic molecule.

According to a practical example of the invention, the inerting agent for nonswelling clays is a polymer having a molecular weight less than 1000000 g/mol, preferably less than 500000 g/mol, more preferably less than 100000 g/mol, even more preferably less than 50000 g/mol.

The inerting agent for nonswelling clays can comprise at least 10, preferably at least 50, more preferably at least 100 atoms, each capable of forming at least one hydrogen bond.

The inerting agent for nonswelling clays can be a polymer or a copolymer comprising at least one monomer having at least one atom capable of forming at least one hydrogen bond.

According to a practical example of the invention, the inerting agent for nonswelling clays is selected from the group comprising an alkyleneoxy (for example ethylene glycol and/or propylene glycol or PEG), a crown ether, a polyvinyl alcohol, a gluconate, a heptagluconate, a heptagluconic acid, a gluconic acid, a polysaccharide notably cellulose or chitin, dextrin, cellulose derivatives, chitosan, alginates, hemicellulose, pectin, polyols or proteins or a mixture of these compounds.

The inerting agent for nonswelling clays can comprise hydroxyl functions. Preferably, the inerting agent for nonswelling clays is a polyvinyl alcohol or PVA. As an example, PVA is obtained by partial hydrolysis of a polyvinyl acetate polymer.

According to a practical example of the invention, the inerting agent for nonswelling clays is obtained by a step of polymerization of at least one vinyl acetate monomer or of a similar compound and a step of hydrolysis, the degree of hydrolysis of the organic molecule being less than 95%, preferably less than 94%, more preferably less than 93%.

Relative to the mass of the final hydraulic binder, the amount of the inerting agent is from 0.01 to 5 wt %, preferably from 0.05 to 3 wt % (percentage calculated from the dry extract of the inerting agent) relative to the mass of the hydraulic binder.

The amount of the inerting agent in the hydraulic composition is, according to a practical example of the invention, from 4 to 15 wt % of dry extract of the inerting agent relative to the dry mass of clays in the hydraulic composition, preferably from 6 to 10 wt % of dry extract of inerting agent relative to the dry mass of clays.

The amount of clays in the hydraulic composition is, according to a practical example of the invention, from 0.5 to 5 wt % of dry clays relative to the mass of dry sand. The amount of clays in the hydraulic composition is, according to a practical example of the invention, from 1 to 50 kg of dry clays per cubic metre of fresh concrete.

Binder and Hydraulic Composition

The present invention also relates to a hydraulic binder comprising a plasticizing mixture as defined above.

Preferably, the hydraulic binder is a cement.

The hydraulic binder intended to form a hydraulic composition, notably a wet concrete, generally comprises, relative to the mass of the dry binder:
99.5 to 90% of cement, for example a Portland cement;
0.5 to 10% of the plasticizing mixture,

Advantageously, the binder comprises:
99 to 95% of cement, for example a Portland cement;
1 to 5% of the plasticizing mixture.

The Portland cement complies with the classes of cement described in European standard EN 197-1. For example, a cement CEM1 52.5 N or R, CEM2 of type 32.5, 32.5 R, 42, 5 or 42.5 R can be used. The cement can be of the HIS (high initial strength) type.

The present invention also relates to a hydraulic composition comprising a hydraulic binder as defined above and aggregates.

Preferably, the hydraulic composition according to the invention is a cement slurry, a mortar or a concrete.

The concrete can, in addition to the plasticizing mixture, contain other types of admixtures commonly used in concretes.

As examples of admixtures which can be used, we may mention: air entraining agents, antifoaming agents, corrosion inhibitors, agents for reducing shrinkage, fibres, pigments, rheology modifiers, hydration precursors, agents to aid pumpability, alkali reaction reducing agents, reinforcing agents, water-repelling compounds, accelerators, retarders and mixtures thereof.

The invention further relates to a method of manufacturing a hydraulic composition according to the invention comprising a step of bringing the plasticizing mixture, mixing water and a hydraulic binder in contact.

The components constituting the plasticizing mixture can be mixed before bringing the plasticizing mixture, mixing water and hydraulic binder in contact. As a variant, the components constituting the plasticizing mixture can be brought in contact with the mixing water and the hydraulic binder independently of one another.

According to a practical example of the method according to the invention, the components of the hydraulic composition can be used by adding all of the components of the plasticizing mixture right at the start, during mixing of the concrete at the concrete mixing plant; the cement is mixed with the complete plasticizing mixture, in particular the inerting agent, the first superplasticizer and the second superplasticizer. Mixing at the concrete mixing plant can be carried out either in a stationary mixer, or in a truck mixer when the latter is used directly as a mixer. The invention therefore also relates to a method in which all the components are introduced at the moment of mixing the hydraulic binder with the aggregates and the water.

Preferably, the plasticizing mixture used in the method according to the invention is in the form of solution, emulsion, suspension, powder, or immobilized on a support.

Preferably, the contacting step of the method according to the invention is carried out in one of the following ways:
the plasticizing mixture is added at the same time as and/or in the mixing water;
the liquefying mixture is added directly to at least one of the components of the hydraulic composition before adding the mixing water;
the plasticizing mixture is added during mixing; and
the plasticizing mixture is added to the hydraulic composition, preferably at the moment of pouring the hydraulic composition.

Preferably, the components of the hydraulic composition to which the plasticizing mixture can be added are aggregates, fibres, a hydraulic binder, slag, fumed silica, fly-ash, limestone or siliceous fillers, pozzolanas, admixtures, etc.

Advantageously, when the plasticizing mixture is added during mixing, it can be added at the start, in the middle or at the end of said mixing. It can even be envisaged to add the plasticizing mixture last, just before stopping the mixer in which the components are mixed.

The plasticizing mixture used in the method according to the invention has the same characteristics as the plasticizing mixture used in the hydraulic binder according to the invention or the hydraulic composition according to the invention.

The hydraulic composition comprises conventional aggregates (sands, gravels and/or stones). Preferably, the constituents of the final composition have a size less than or equal to 20 mm. The composition can thus be pumped easily.

The invention further relates to an element for the construction area made using a hydraulic binder according to the invention or a hydraulic composition according to the invention, as described above.

Installation for Production of a Hydraulic Composition

The present invention also relates to an installation for production of the hydraulic composition described above. The installation comprises at least:
a means for supplying the inerting agent;
a means for supplying the first superplasticizer;
a means for supplying the second superplasticizer;
a means for supplying at least one parameter; and
a suitable processor for independently controlling the means for supplying the inerting agent, the means for supplying the first superplasticizer and the means for supplying at least one parameter as a function of the value of said physical parameter of the hydraulic composition and/or a physical parameter of the method of production of the hydraulic composition.

The installation according to the invention advantageously makes it possible to adapt the composition of the plasticizing mixture in relation to the measured value of the physical parameter.

According to a practical example, the means for supplying the physical parameter is a temperature sensor.

The invention will be described in more detail by means of the following, nonlimiting, examples, together with the figures, in which:

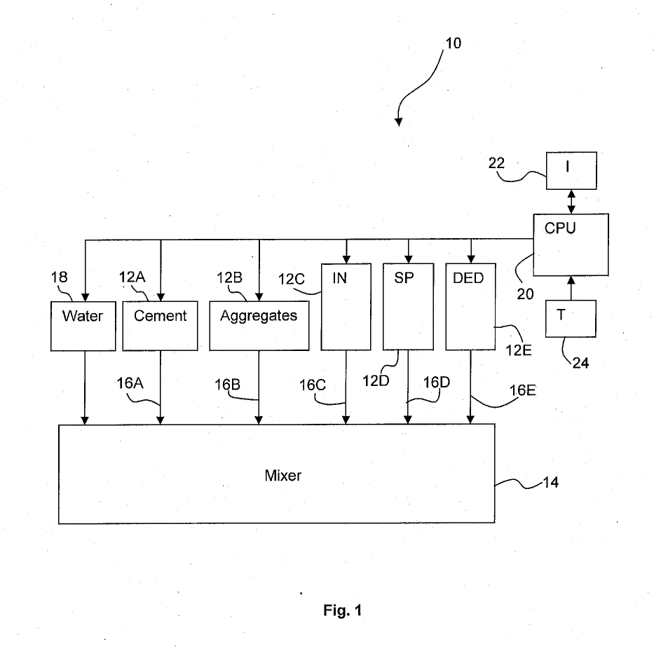

FIG. 1 shows, schematically, an example of an installation for manufacturing concrete according to the invention;

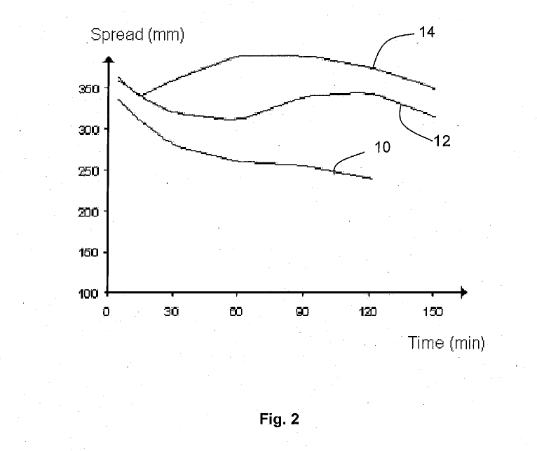

FIG. 2 shows the variation of the spread of a mortar comprising a conventional plasticizing mixture and the variation of the spread of a mortar comprising a plasticizing mixture according to a first embodiment of the invention; and

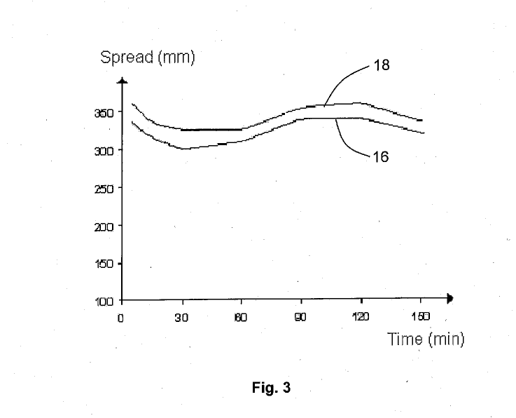

FIG. 3 shows the variation of the spread of a mortar comprising a plasticizing mixture according to the first embodiment of the invention and the variation of the spread of a mortar comprising a plasticizing mixture according to a third embodiment of the invention.

FIG. 1 shows, schematically, a practical example of an installation 10 for producing concrete. Only the elements necessary for understanding the invention are described. The production installation 10 comprises for example means for storing or for supplying 12A to 12E the components of the hydraulic composition. As an example, in the case when the hydraulic composition is concrete, installation 10 can comprise at least one storage silo for at least one type of cement 12A (Cement) and at least one storage silo 12B (Aggregates) for at least one type of aggregate. Installation 10 comprises a storage tank 12C, 12D and 12E for each compound of the plasticizing mixture. The inerting agent (or a mixture of inerting agents) is stored in storage tank 12C (IN), for example in liquid form. The superplasticizer with immediate action (or a mixture of superplasticizers with immediate action, or a mixture of at least one superplasticizer with immediate action and a plasticizer, or a mixture of at least one superplasticizer with immediate action and a substance of the gluconate type) is stored in storage tank 12D (SP), for example in liquid form. The superplasticizer with delayed action (or a mixture of superplasticizers with delayed action) is stored in storage tank 12E (DED), for example in liquid form. Other tanks can be provided, each tank containing an admixture or a mixture of admixtures of a particular type, for example air entraining agents, antifoaming agents, accelerators, retarders, pigments, corrosion inhibitors, viscosity modifiers, etc.

Installation 10 comprises a mixing device 14 (Mixer) and conveying means 16A to 16E connecting each storage means 12A to 12E to the mixing device 14. The mixing device 14 can correspond to a dedicated mixer, as in a concrete mixing plant or can correspond to the drum of a truck mixer. The installation further comprises means 18 for supplying water to the mixing device 14.

Installation 10 comprises a suitable processor 20 (CPU) for controlling the storage means 12A to 12E, the conveying means 16A to 16E, the mixing device 14 and the means for supplying water 18. The processor 20 is connected to an interface 22 (I).

The processor 20 can be connected to a sensor 24 of a physical parameter (T). As an example, sensor 24 is a temperature sensor 24 (T) and/or a moisture sensor, notably of the moisture absorbed by the aggregates. The processor 20 can be connected to several sensors. The processor 20 is suitable for controlling the transport of a given amount of the component stored in each storage means 12A to 12E to the mixing device 14 in relation to the composition of the concrete to be produced.

According to an embodiment of the invention, the processor 20 comprises a memory, not shown, in which various formulations of concrete are stored. Each formulation comprises, for example, the amount of each component (cement, aggregates, inerting agent, superplasticizer with immediate action and superplasticizer with delayed action, water) to be provided for making 1 m³ of concrete.

According to an embodiment of the invention, the processor 20 is suitable for determining a concrete formulation from at least one parameter supplied by an operator via the interface 22 and/or supplied by the sensor 24. The parameters are, for example, the desired performance parameters of the concrete selected from bending strength, compressive strength, slump/spread, setting time or air content. The parameters can specify characteristics of the concrete, for example the type and/or amount of at least one component of the concrete, notably the cement, the type of aggregate, the origin of the cement, the origin of the aggregates, composition of the cement, composition of the aggregates, type of impurities in the components, ratios between components of the concrete, notably the water/cement ratio. The parameters can further comprise the temperature and the moisture content of the aggregates.

According to an embodiment of the invention, the processor 20 can adjust the amounts of the components to be used as a function of the value of the parameters supplied by the interface and/or the sensor 24. In particular, the processor 20 can adjust the amounts of the inerting agent, of the superplasticizer with immediate action and of the superplasticizer with delayed action.

### EXAMPLES

### Measurement of the Cationicity of a Cationic Polymer

The cationicity or cationic charge density (in meq/g) represents the quantity of charges (in mmol) carried by 1 g of polymer. This property is measured by colloidal titration with an anionic polymer in the presence of a colour indicator sensitive to the ionicity of the polymer in excess.

In the examples given below, the cationicity was determined as follows. The following elements were placed in a suitable vessel:
60 ml of a buffer solution of sodium phosphate at 0.001 M-pH 6; and
1 ml of solution of o-toluidine blue at 4.1×10″⁴ M; then
0.5 ml of solution of cationic polymer to be assayed.

This solution was titrated with a solution of potassium polyvinylsulfate until the indicator changed color.

The cationicity was found from the following relation:

Cationicity (meq/g)=(Vₑₚᵥₛₖ*Nₚᵥₛₖ)/(V_{pc}*C_{pc})

in which:
V_{pc} is the volume of solution of the cationic polymer;
C_{pc} is the concentration of cationic polymer in solution;
Vₑₚᵥₛₖ is the volume of solution of potassium polyvinylsulfate; and
Nₚᵥₛₖ is the normality of the solution of potassium polyvinylsulfate.

Measurement of the Intrinsic Viscosity of a Cationic Polymer

The intrinsic viscosity of the cationic polymers was measured in a 3M NaCl solution, with a capillary viscosimeter of the Ubbelhode type, at 25° C.

The flow time was measured in the capillary tube between 2 reference marks for the solvent and solutions of the polymer at different concentrations. The specific viscosity was obtained for each concentration, by dividing the difference between the flow times of the solution of polymer and of the solvent, by the flow time of the solvent. The reduced viscosity was calculated by dividing the specific viscosity by the concentration of the polymer solution. By plotting the straight line of the reduced viscosity as a function of the concentration of the polymer solution, a straight line was obtained. The intersection of this straight line with the ordinate corresponded to the intrinsic viscosity for a concentration equal to zero.

This value was correlated with the average molecular weight of a polymer.

Method of Manufacturing the Superplasticizer with Delayed Action

The following compounds were weighed in a 2000-mL four-necked flask:
557 g of demineralized water;
4.0 g of acrylic acid (supplier: Aldrich); and
409.5 g of methoxypoly(ethylene glycol) acrylate of mass 1100 g/mol (supplier: NK ester).

The reaction setup was equipped with a mechanical stirrer, temperature probe, nitrogen supply and condenser. A heated oil bath was installed under the flask and the temperature was set at 85° C. The circulation of cooling water, bubbling of nitrogen and stirring of the medium were also started. Once the set temperature was reached, 1.0 g of thioglycolic acid (supplier: Aldrich) was added, followed by addition of 5.77 g of Vazo 68 (supplier: Dupont), which corresponded to polymerization time zero. The reaction mixture was left to react for 2 h at 85° C. before withdrawing the heating bath. Once at room temperature, 11.0 g of 50% NaOH was added to the reaction mixture, as well as demineralized water. The solution of polymers was used as it was after determination of its dry residue value.

Formulation of the Mortar

TABLE 1
Formulation of the mortar

| Constituent | Weight (g) |
|---|---|
| Cement | 480 |
| Betocarb limestone filler | 359 |
| PE2LS sand | 200 |
| Standardized sand | 1350 |
| Water for prewetting | 100 |
| Mixing water | 227 |
| Additives | According to the |
| | examples |

The cement was a cement of the CEM II 42.5N CE CP2 NF type (obtained from Lafarge Le Teil works).

The filler was a limestone material (Bétocarb d'Erbray which comprises about 90 wt % of 100 μm sieve undersize) (supplier: OMYA).

The standardized sand was a silica sand according to standard EN 196.1 (supplier: Société Nouvelle du Littoral).

The PE2LS sand was a silica sand with diameter less than or equal to 0.315 mm (supplier: Fulchiron).

The admixtures comprised at least one superplasticizer with immediate action and one superplasticizer with delayed action and optionally an inerting agent.

The sands could comprise clays.

Protocol for Preparation of the Mortar:

A mortar with the composition shown in table 1 was prepared in the bowl of a Perrier mixer.

The sands, and then the water for prewetting were added with stirring at low speed (140 rev/min), then left to stand for 4 minutes before introducing the binders (cement and filler). Mixing was resumed for 1 minute at low speed and then the mixing water together with the admixtures was added in 30 seconds. Finally, mixing continued for a further 2 minutes at 280 rev/min. The mortar was produced at a constant temperature of 20° C. and a relative humidity of 70%.

Measurement of Spread

The spread of a mortar was measured at 20° C. using an Abrams mini-cone with a volume of 800 mL. The cone dimensions were as follows:
diameter of the circle of the upper base: 50+/−0.5 mm;
diameter of the circle of the lower base: 100+/−0.5 mm; and
height: 150+/−0.5 mm.

The cone was placed on a dried glass plate and filled with fresh mortar. It was then leveled. Removal of the cone caused the mortar to slump on the glass plate. The diameter of the disk obtained was measured in millimetres +/−5 mm. This is the spread of the mortar.

### Example 1

A mortar M1 according to the formulation in table 1 was made using just one superplasticizer with immediate action SP. The superplasticizer with immediate action SP corresponded to the product marketed under the designation OPT220 by the company Chryso.

A mortar M2 according to the formulation in table 1 was made using just one superplasticizer with delayed action DED. The superplasticizer with delayed action DED was the polymer of the PCP type obtained by the method described above.

A mortar M3 according to the formulation in table 1 was made using a plasticizing mixture comprising the superplasticizer with immediate action SP OPT220 and the superplasticizer with delayed action DED.

A mortar M4 according to the formulation in table 1 was made using only an inerting agent IN. The inerting agent used was an epichlorohydrin-dimethylamine polyamine, having a cationicity of 7.3 meq/g and an intrinsic viscosity of 0.04 dl/g (FL2250; dry extract: 54.5 wt %; supplier: SNF).

A mortar M5 according to the formulation in table 1 was made using a plasticizing mixture comprising the superplasticizer with immediate action SP and the inerting agent IN.

A mortar M6 according to the formulation in table 1 was made using a plasticizing mixture comprising the superplasticizer with immediate action SP, the superplasticizer with delayed action DED and the inerting agent IN.

The concentrations of the components of the plasticizing mixture in mortars M1 to M6 are shown below in table 2.

TABLE 2

| | Dosage of the | Dosage of the | Dosage of the |
|---|---|---|---|
| | superplasticizer with | superplasticizer with | inerting agent |
| | immediate action, SP | delayed action, DED | IN (% polymer |
| | (% polymer dry | (% polymer dry | dry mass/ |
| Mortar | mass/cement mass) | mass/cement mass) | cement mass) |
| M1 | 0.14% | — | — |
| M2 | — | 0.30% | — |
| M3 | 0.14% | 0.10% | — |
| M4 | — | — | 0.10% |
| M5 | 0.14% | — | 0.10% |
| M6 | 0.14% | 0.10% | 0.10% |

The spread at 5 minutes was measured for each mortar M1 to M6. The results are presented below in table 3.

TABLE 3

| | M1 | M2 | M3 | M4 | M5 | M6 |
|---|---|---|---|---|---|---|
| Spread at 5 min (mm) | 200 | 100 | 335 | 100 | 345 | 360 |

For mortar M1 comprising only the superplasticizet with immediate action SP, the spread at 5 minutes was 200 mm.

For mortar M2 comprising only the superplasticizer with delayed action DED, the spread at 5 minutes was 100 mm, which tends to show, as desired, that the superplasticizer with delayed action DED, even with a high dosage, did not have an initial plasticizing action.

For mortar M3 comprising the superplasticizer with immediate action SP and the superplasticizer with delayed action DED, the spread at 5 minutes was 335 mm, i.e. greater than the spread at 5 minutes of mortar M1. This tends to prove that the superplasticizer with delayed action DED served for at least partially inerting the clays contained in mortar M3, which prevented some of the superplasticizer with immediate action SP being consumed by the clays, leading to an increase in the spread at 5 minutes.

For mortar M4 comprising only the inerting agent IN, the spread at 5 minutes was 100 mm, which confirmed that the inerting agent IN does not have any plasticizing action.

For mortar M5 comprising the superplasticizer with immediate action SP and the inerting agent IN, the spread at 5 minutes was 345 mm, i.e. greater than the spread at 5 minutes of mortar M1. This confirmed the presence of clays in mortar M5 which were rendered inert by the inerting agent IN, which prevented some of the superplasticizer with immediate action SP being consumed by the clays, leading to an increase in the spread at 5 minutes. This confirmed, moreover, that at least some of the superplasticizer with delayed action DED served for at least partially inerting the clays contained in mortar M3. The spread at 5 minutes obtained for mortar M5 was slightly greater than the spread at 5 minutes obtained for mortar M3, which tends to show that the inerting agent IN was more effective for inerting the clays than the superplasticizer with delayed action DED.

For mortar M6 comprising the superplasticizer with immediate action SP, the superplasticizer with delayed action DED and the inerting agent IN, the spread at 5 minutes was 360 mm, i.e. slightly greater than the spread obtained for mortar M5. The clays had been rendered inert. The plasticizing action of the superplasticizer with immediate action SP had not been degraded. Moreover, the spread at 5 minutes of mortar M6 was closer to the spread at 5 minutes obtained for mortar M5 than the spread at 5 minutes obtained for mortar M3. A possible explanation is that the inerting action of the clays was performed for mortar M6 by the inerting agent IN and not by the superplasticizer with delayed action DED.

### Example 2

A mortar M7 according to the formulation in table 1 was made using a plasticizing mixture according to a second embodiment of the present invention, comprising the superplasticizer with immediate action SP, a superplasticizer with delayed action DED′ and the inerting agent FI2250. The superplasticizer with delayed action DED′ corresponded to the product marketed under the designation RheoTEC Z-60 by the company BASF. It is a polymer of the PCP type.

The concentrations of the components of the plasticizing mixture in mortars M3, M6 and M7 are shown below in table 4.

TABLE 4

| | Dosage of the | Dosage of the | Dosage of the | Dosage of |
|---|---|---|---|---|
| | superplasticizer | superplasticizer | superplasticizer | the inerting |
| | with immediate | with delayed | with delayed | agent IN |
| | action, SP | action, DED | action, DED′ | (% polymer |
| | (% polymer | (% polymer | (% polymer dry | dry |
| | dry mass/ | dry mass/ | mass/cement | mass/cement |
| Mortar | cement mass) | cement mass) | mass) | mass) |
| M3 | 0.14% | 0.10% | — | — |
| M6 | 0.14% | 0.10% | — | 0.10% |
| M7 | 0.14% | — | 0.10% | 0.10% |

The variation of the spread was measured for each mortar M3, M6 and M7. The results are presented below in table 5 and are illustrated in FIG. 2, in which curve 10 shows the variation of the spread of mortar M3, curve 12 shows the variation of the spread of mortar M6 and curve 14 shows the variation of the spread of mortar M7.

TABLE 5

Spread at 20° C. (mm)

| | 5 min | 30 min | 60 min | 120 min |
|---|---|---|---|---|
| M3 | 335 | 280 | 260 | 240 |
| M6 | 360 | 320 | 310 | 345 |
| M7 | 360 | 360 | 390 | 375 |

The spread decreased continuously for mortar M3. The plasticizing contribution of the superplasticizer DED was clearly visible after 30 minutes for mortar M6 since an inflection is observed on curve 12. The inerting agent IN in mortar M6 permitted the superplasticizer with delayed action DED to perform just its plasticizing function. The curve of the variation 14 of mortar M7 has roughly the same general shape as curve 12. However, relative to mortar M6, mortar M7 displayed a greater spread for at least 2.5 h.

### Example 3

A mortar M8 according to the formulation in table 1 was made using a plasticizing mixture according to the first embodiment of the present invention, comprising the superplasticizer with immediate action SP, the superplasticizer with delayed action DED and the inerting agent IN.

A mortar M9 according to the formulation in table 1 was made using a plasticizing mixture according to a third embodiment of the present invention, comprising the superplasticizer with immediate action SP, the superplasticizer with delayed action DED and an inerting agent IN′. The inerting agent IN′ corresponded to polyvinyl alcohol having a degree of hydrolysis of 75% and a molecular weight of 2000 g/mol (supplier: Aldrich).

The concentrations of the components of the plasticizing mixture in mortars M8 and M9 are shown below in table 6.

TABLE 6

| | Dosage of the | Dosage of the | Dosage of | |
|---|---|---|---|---|
| | superplasticizer | superplasticizer | the inerting | Dosage of the |
| | with immediate | with delayed | agent IN | inerting agent |
| | action SP (% | action DED | (% polymer | IN′ (% polymer |
| | polymer dry | (% polymer | dry | dry |
| | mass/ | dry mass/ | mass/cement | mass/cement |
| Mortar | cement mass) | cement mass) | mass) | mass) |
| M8 | 0.14% | 0.10% | 0.05% | — |
| M9 | 0.14% | 0.10% | — | 0.05% |

The variation of the spread was measured for each mortar M8 and M9. The results are presented below in table 7 and are illustrated in FIG. 3, in which curve 16 shows the variation of the spread of mortar M8 and curve 18 shows the variation of the spread of mortar M9.

TABLE 7

Spread at 20° C. (mm)

| | 5 min | 30 min | 60 min | 120 min |
|---|---|---|---|---|
| M8 | 335 | 300 | 310 | 340 |
| M9 | 360 | 325 | 325 | 360 |

Relative to mortar M8, mortar M9 displayed a slightly greater spread for at least 2.5 h. Moreover, advantageously, the inerting agent IN′ does not comprise chlorine whereas the inerting agent IN is generally used in the form of a chloride salt and supplies amounts of chlorine which may be incompatible with the standards for manufacture of concrete. In general, curves 16 and 18 illustrate the fact that the inerting of the harmful effects of clay on the superplasticizer with delayed action is obtained independently of the chemical nature of the inerting agent.

1. A mixture for a hydraulic composition, comprising:
an inerting agent suitable for at least partially neutralizing the harmful effects of impurities in the hydraulic composition on the workability of the hydraulic composition;
a first superplasticizer different from the inerting agent; and
a second superplasticizer different from the first superplasticizer and the inerting agent and having a maximum plasticizing action at 20° C. developing after the peak of the plasticizing action at 20° C. of the first superplasticizer.

2. The mixture as claimed in claim 1, wherein the density of adsorption sites of the second superplasticizer increases in the window of workability of the hydraulic composition.

3. The mixture as claimed in claim 1, wherein the inerting agent corresponds to a cationic polymer having a cationic charge density greater than 0.5 meq/g and an intrinsic viscosity less than 1 dl/g.

4. The mixture as claimed in claim 3, wherein the cationic polymer has a cationic charge density greater than 2 meq/g.

5. The mixture as claimed in claim 3, wherein the cationic polymer has an intrinsic viscosity less than 0.6 dl/g.

6. The mixture as claimed in claim 1, wherein the inerting agent is a vinyl alcohol polymer.

7. The mixture as claimed in claim 1, wherein the second superplasticizer is of the polyalkyleneoxide polycarboxylate type.

8. The mixture as claimed in claim 1, wherein the first superplasticizer is of the polyalkyleneoxide polycarboxylate type.

9. A hydraulic binder comprising:
cement; and
the mixture as claimed in claim 1.

10. A hydraulic composition comprising a hydraulic binder as claimed in claim 9 mixed with aggregates and water.

11. An element for the construction area, the element produced using the hydraulic binder as claimed in claim 9.

12. An installation for producing the hydraulic composition as claimed in claim 10, comprising:
a means for supplying the inerting agent;
a means for supplying the first superplasticizer;
a means for supplying the second superplasticizer;
a means for supplying at least one parameter; and
a processor suitable for independently controlling the means for supplying the inerting agent, the means for supplying the first superplasticizer and the means for supplying at least one parameter as a function of the value of said physical parameter of the hydraulic composition and/or a physical parameter of the method of production of the hydraulic composition.

13. The installation as claimed in claim 12, in which the means for supplying the physical parameter is a temperature sensor.

14. An element for the construction area, the element produced using the hydraulic composition as claimed in claim 10.

15. An installation for producing the hydraulic composition as claimed in claim 10, comprising:
a conveyor configured to supply the inerting agent;
a conveyor configured to supply the first superplasticizer;
a conveyor configured to supply the second superplasticizer;
a sensor configured to supply a parameter of the hydraulic composition; and
a processor configured to independently control the conveyor to supply the inerting agent, the conveyor configured to supply the first superplasticizer and the sensor configured to supply the physical parameter as a function of a value of said physical parameter of the hydraulic composition and/or a physical parameter of a method of production of the hydraulic composition.
